(19) United States
(12) Patent Application Publication
(10) Pub. No.: US 2007/0275787 A1
(43) Pub. Date: Nov. 29, 2007

(54) Bowling ball having an RFID tag

(76) Inventors: Roland C. Bouchard, Grand Rapids, MI (US); Alfred J. Dabrowski JR., Muskegon, MI (US); Raymond M. Edwards, Fruitport, MI (US); Kurt A. Dykema, Holland, MI (US)

Correspondence Address: BRINKS HOFER GILSON & LIONE, P.O. BOX 10395, CHICAGO, IL, 60610, US

(21) Appl. No.: 11/636,409

(22) Filed: Dec. 8, 2006

Related U.S. Application Data
(60) Provisional application No. 60/748,996, filed on Dec. 9, 2005.

(51) Int. Cl. A63B 37/00; G08B 7/06; G08B 13/14

(52) U.S. Cl. 473/125; 340/572.8

(57) ABSTRACT

A bowling ball with a radio frequency identification (RFID) tag is disclosed, as are methods and systems for manufacturing such a bowling ball. Methods and systems for using a bowling ball with an RFID tag are also disclosed.

### CROSS-REFERENCE TO RELATED APPLICATION

This application claims the benefit of U.S. Provisional Application No. 60/748,996, filed Dec. 9, 2005, which is hereby incorporated by reference.

### BACKGROUND

The game of bowling is typically played on a bowling lane with a plurality of pins on the lane at the start of a game. In a conventional ten pin bowling game, each bowler is allowed to roll two balls in an attempt to knock down all of the pins. The throwing of two balls constitutes what is known as a frame, except that three balls may be permitted in the tenth frame, and the completion of ten frames comprises one game. The player's score is determined according to the number of pins that are knocked down in each frame. U.S. Pat. Nos. 3,447,804 and 3,645,528, which are assigned to Brunswick Corporation, disclose a bowling ball including a tuned loading circuit and relate to differentiating bowling balls during their use on a bowling lane to, for example, control equipment associated with the bowling lane for purposes of scoring, ball handing, and the like, during a game of bowling.

### BRIEF DESCRIPTION OF THE DRAWINGS

FIG. 1 is an illustration of an embodiment showing a bowling ball with a round inner core.

FIG. 2 is an illustration of a bowling ball core mold of an embodiment.

FIG. 3 is an illustration of a bowling ball core mold of an embodiment with weight block material at the bottom.

FIG. 4 is an illustration of an embodiment showing RFID tag suspension while pouring resin to create a core.

FIG. 5 is an illustration of a “pour weight block” step of a bowling ball manufacturing process of an embodiment.

FIG. 6 is an illustration of a “pour core fill” step of a bowling ball manufacturing process of an embodiment.

FIG. 7 is an illustration of a “demold and deknob” step of a bowling ball manufacturing process of an embodiment.

FIG. 8 is an illustration of a “lathe turn core” step of a bowling ball manufacturing process of an embodiment.

FIG. 9 is an illustration of a bowling ball core of an embodiment with a drilled hole location.

FIG. 10 is an illustration of a “core insertion” step of a bowling ball manufacturing process of an embodiment.

FIG. 11 is an illustration of a “cast ball” step of a bowling ball manufacturing process of an embodiment.

FIG. 12 is an illustration of another “demold and deknob” step of a bowling ball manufacturing process of an embodiment.

FIG. 13 is an illustration of a “lathe turn ball” step of a bowling ball manufacturing process of an embodiment.

FIG. 14 is an illustration of an “engrave and fill” step of a bowling ball manufacturing process of an embodiment.

FIG. 15 is an illustration of a “finish grind and buff or wet sand” step of a bowling ball manufacturing process of an embodiment.

### DETAILED DESCRIPTION OF THE PRESENTLY PREFERRED EMBODIMENTS

General Overview

The following embodiments relate to a bowling ball having a radio frequency identification (RFID) tag. RFID tags are normally attached to items to track them through a warehouse or in monitoring inventory levels. The use of RFID tags with bowling balls (any size (e.g., large or small)) could be as simple as attaching a tag to the outside of the ball or have the tag attached to the packaging material surrounding the ball, as is done with most items that use tags. If the tag were attached to the outside of the ball, it would, more likely than not, have to be removed prior to its use on a lane. If the intent were to only track the ball through delivery of the ball through the warehouse to the customer, either of these methods would suffice.

RFID tags within bowling balls would allow for many possibilities during the manufacturing process through tracking the delivery of balls to customers. In addition, the use of RFID-tagged bowling balls within a bowling center provides many diverse opportunities including tracking the performance of a ball or type of ball, assisting in the location of a specific ball within the center, or simply identifying a ball's specific characteristics to a monitoring system. These and other applications are described in more detail below.

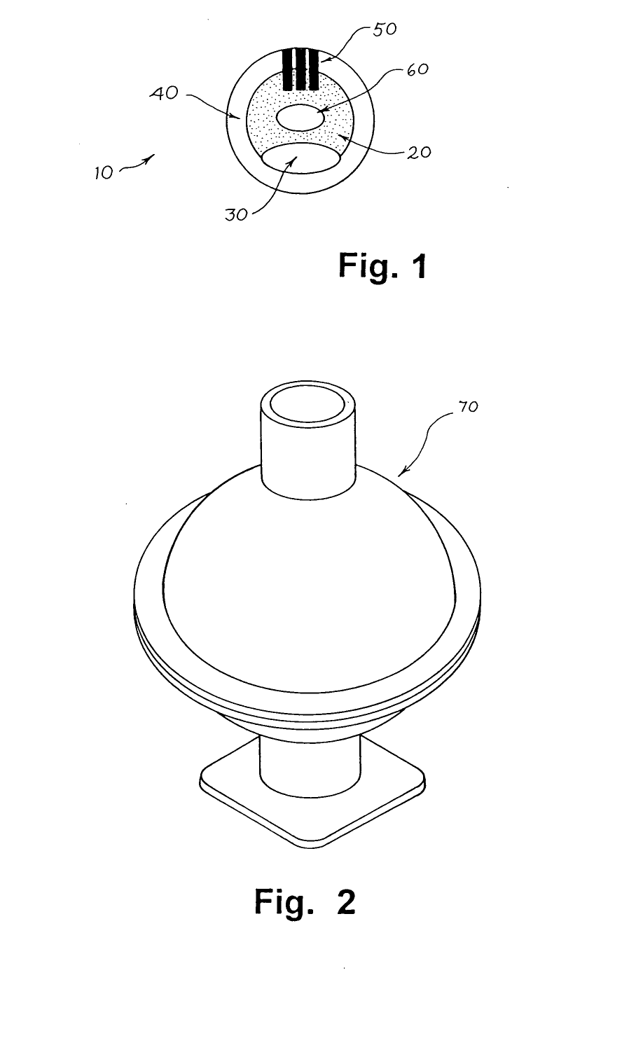

However, the manufacture of bowling balls contains processes that include caustic chemicals and extreme temperatures. In addition, high performance bowling balls include inner cores of various densities and configurations to achieve the performance required in achieving high scores and consistent performance on the lane. With reference to FIG. 1, a bowling ball 10 typically comprises a core 20, a weight block 30, an outer layer 40, and finger holes 50. A complicating factor for the placement of an RFID tag 60 is that the bowling ball 10 needs to be drilled for the finger holes 50, thus limiting the size of the tag 60 and its location within the ball 10 since drilling into the tag 60 will likely result in its destruction.

Hence, the selection of a tag that will survive the extreme heat during the exothermic curing process and the caustic materials (resin, filler, etc.) that are poured into the mold and is of a size that will reduce or eliminate the likelihood of damage during drilling is desired. Insertion of the tag within the center core would be of greatest benefit during the manufacturing and drilling processes since the tag would be present during all of the manufacturing process and would be in a location away from the finger holes. Unfortunately, this is also the area of the highest heat (up to 400° F.)

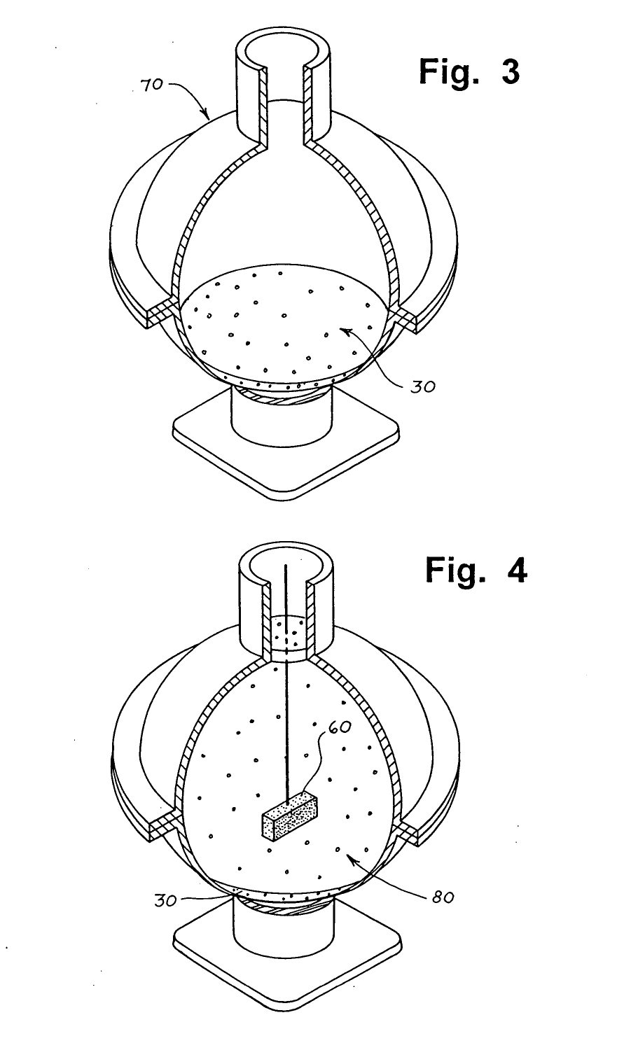

With reference to FIGS. 2-4, in one embodiment, the tag 60 is suspended or placed within the core mold 70 just prior to the resin 80 being poured in and just after the weight block material 30 has been poured into the mold 70. Preferably, care would be taken to assure that the tag 60 did not drift from the center of the mold 70.

Selection Placement, and Orientation of an RFID Tag

The exothermic reaction associated with the core curing process can damage an RFID tag, and the presence of the tag can also cause a stress point or fracture within the core. This would weaken the ball and would lead to high failure rates. To minimize this impact, it is preferred to use a tag that can withstand the temperatures experienced during curing. Alternatively, a method can be used that will aid in the removal of heat from the core without subjecting the core to temperatures that are too low, which would in itself cause stress points and failures.

It is also preferred that the tag be small in size to avoid the problems associated with ball drilling mentioned above. Though this is not a problem for small bowling balls that are not drilled, the small sized tag will be less of a problem in assuring that the tag placement remains near the center of the ball.

In view of present tag technology, an epoxy encased, ceramic or glass encapsulated tag can be used, thus allowing the contained tag to survive the caustic chemicals and extreme temperatures encountered. The use of tags lesser able to survive the high temperatures and caustic chemicals (e.g., plastic tags) may be suited for cores and balls that cure with less heat buildup within the core or ball (i.e., heavier balls).

The tag may be suspended within the mold on a string or wire during the pour, or it may be placed within the core after the pouring by pushing it in place using a small stick or other suitable object. Alternatively, the pouring may be done in increments with a partial pour, placement of the tag through one of many mechanisms (including the one described above), and a final pouring over the placed tag.

The orientation of the tag can be in any axis since the reading of data from these cores and balls can be achieved by rolling the ball or core through a circular antenna in close proximity to the core or ball. (The antenna could be oblong or elliptical as long as the ball rolls through or near the opening of the coil/antenna.) The antenna tuning coil and tag reader will be positioned near the antenna, although several antennas may be multiplexed into one tuning coil/reader.

Example of a Bowling Ball Manufacturing Process of an Embodiment

Bowling balls consist of a core that may be cast in various shapes. For ease of explanation, we are only looking at round cores made in two steps. The odd-shaped cores may be made in different shapes, but they are then cast inside a round core and are then handled similarly in the remainder of the ball manufacturing process. The following paragraphs describe the steps in a bowling ball manufacturing process. It should be noted that fewer, more, or different steps can be used.

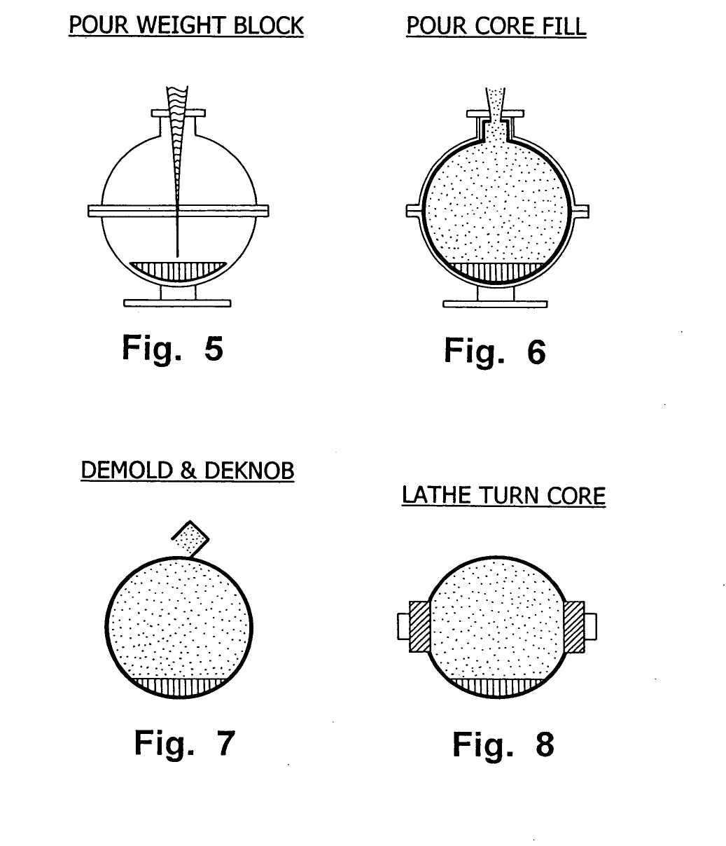

In the “pour weight block” step (see FIG. 5), a round core is made by pouring a resin of a higher density than the remainder of the core. This higher density material settles in the bottom of the core mold as shown below in FIG. 5. The next step of the process is the “pour core fill” step (see FIG. 6). In this step, the remainder of the core mold is filled with the less dense resin. In light balls, lighter materials are blended into the resin to make the resin less dense. This has the unfortunate property of acting as an insulation, which causes the exothermic reaction to go to very high temperatures (up to 400° F). As the core cures, it solidifies. If an RFID tag were inserted into the core at this time, the core could be tracked through the manufacturing process as it becomes one of many possible balls. If the core were one of the odd-shaped ones, the RFID tag could also be inserted at this time, and that core could then be tracked through the manufacturing process. Alternatively, the RFID tag could be inserted into a hole drilled into the odd-shaped core or placed near the odd-shaped core during the outer (round) core casting.

Once the core solidifies and is allowed to cool at room temperature, the core is removed from the mold and the knob (where the fill occurred) is removed. This is shown in the “demold and deknob” step of FIG. 7. A “lathe turn core” step is then performed (see FIG. 8), in which the ball is turned down in a lathe to get it to a smoother, round surface. At this point, all cores, be they consisting of an oddly-shaped inner core and a round outer core, or simply having been cast as a round core as shown above, all look the same. Hence, having an RFID tag to differentiate between the various core possibilities would greatly ease the control of which cores go into which balls and reduce the scrap rate.

Cores are then weighed to assure compliance with the specification requirements.

At this time, if the cores contain an RFID tag, the core could have an actual weight contained within the database for that core. This would be useful in determining the robustness of the core casting process. After the core is weighed, a small location hole is drilled into the surface, typically opposite the weight block or heavy part of the core.

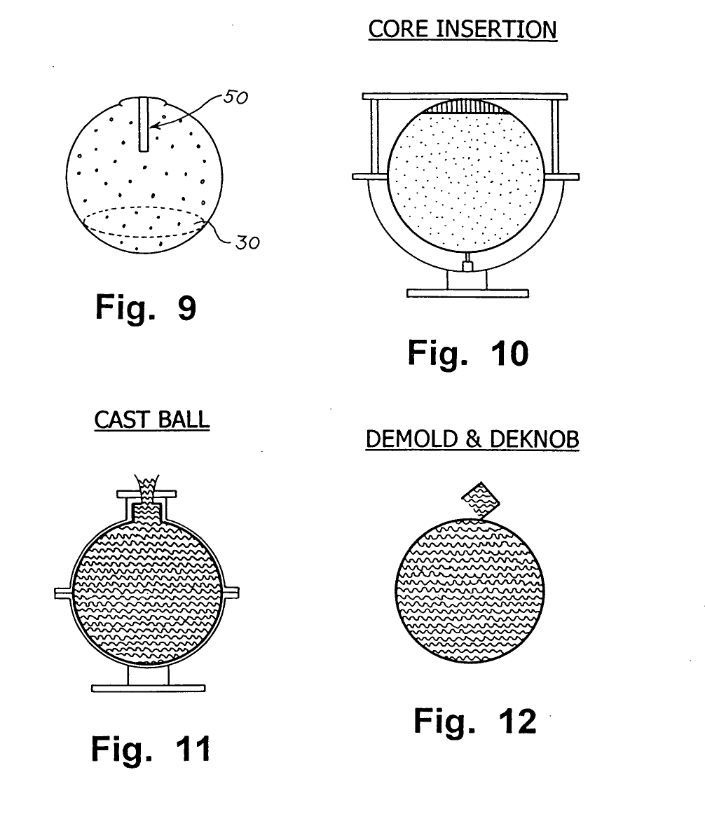

FIG. 9 shows a ball with a drilled hole location 50.

As shown in FIG. 10, a “core insertion” step is then performed in which the core is placed into the ball mold, carefully aligning the drilled location hole with the guide pin located in the bottom of the ball mold. Once placed on the guide pin, a press pushes the core onto the pin top a specific location, thus centering the core within the ball mold.

With an RFID tag within the core, the process control could verify that the core is the proper core for the ball casting material (color, density, type of resin, etc.), and if there was an incompatibility, the process could be halted or corrected.

As in the core casting process, the ball mold is closed, and the outer surface resin for the ball is poured or injected into the mold in the space surrounding the core. (See the “cast ball” step shown in FIG. 11.) Another exothermic reaction occurs at this point as the resin solidifies. However, this reaction is spread out over the surface of the core, and the inner core sees very moderate temperature increases.

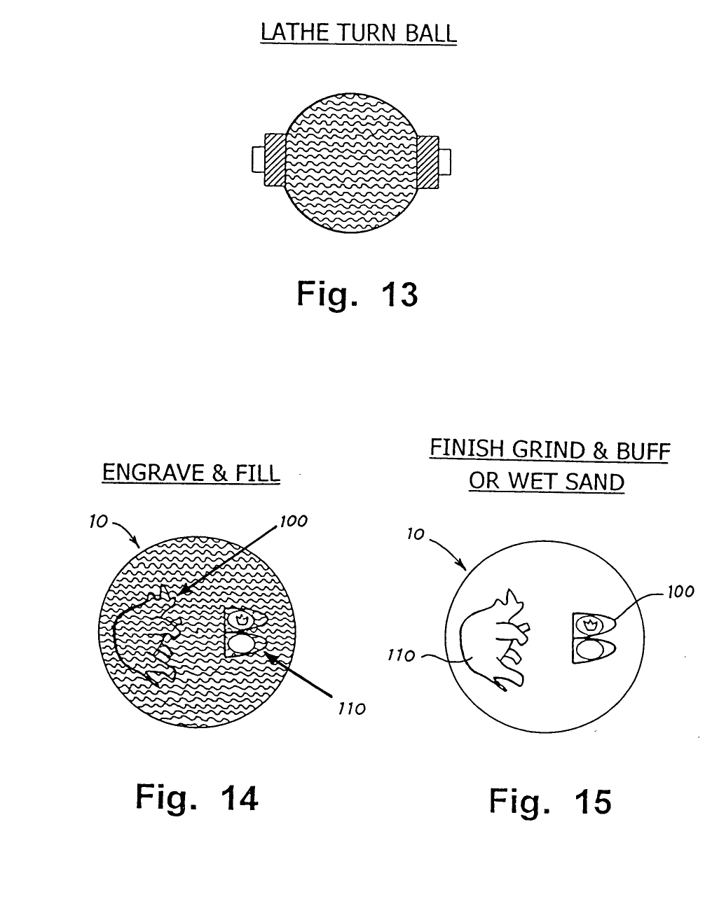

As with the core, once the ball has solidified and cooled, the ball is removed from the mold, de-knobbed and allow to cool again. This is shown in the “demold and deknob” step in FIG. 12. After sufficient time has passed, the ball is turned on a lathe to achieve the roundness required for the final surface of the bowling ball. (See the “lathe turn ball” step of FIG. 13.) The ball is then engraved. The engraving is unique for each ball type. After engraving, a fill material of the proper color for each engraved area of the ball is applied and cured. FIG. 14 shows the “engrave and fill” step and the engraved areas 100, 110.

If the core contained an RFID tag, a verification could be made before the process start to assure that the engravings 100, 110 were proper for the core contained within the ball, i.e. the core tag identified itself as a house ball but the process of engraving was for a high performance ball. Again, the process could be stopped and corrected at this point for any detected variations. In addition, since the serial number of the ball is engraved at this time, the serial number would be automatically entered into the database for the identified core RFID tag number.

The ball is then ground to achieve its final roundness and is buffed or wet-sanded to achieve the luster required. (See the “finish grind and buff or wet sand” step shown in FIG. 15.) The final step in the process is the weighing of the ball, determining exactly where the heaviest spot of the ball is, and packing it in its shipping container. At this point, all specifics are marked on the box and the serial number is entered into a database.

If the core contained the RFID tag, this information would have been garnered as the ball went through the process and associated with the specific RFID tag, either within a database, or it could, additionally or alternatively, be written to the tag itself. Thus, no human intervention would be required, thereby eliminating all human errors and providing automatic controls throughout the process.

After the ball is within the shipping container, it could be tracked through the final packing operation, and its location within the warehouse could be followed. As it is placed on a pallet to be shipped, the pallet RFID tag could then be updated to reflect its content, and the pallet could be tracked as it went out to the shipping dock and loaded on a truck, thus clearly identifying when it left the facility, which transit company picked it up, and who the customer was. All the information could be inserted into a database.

Sample Applications

A RFID tag in a bowling ball can be used for any desired application. As described above, a core with an RFID tag embedded in it can be introduced into the manufacturing process to make a ball. The RFID tag can identify what type of ball the core will become at the end of its manufacturing process (either in a database or in the tag itself. RFID reader antennas can be located at or near the beginning of each process/manufacturing step. When the ball is presented for the next operation, the tag will be read as it passes the antenna, and the ball and process parameters will be evaluated for compatibility. If the ball and the process step are not compatible, the process will not be performed on the ball. Alternatively, the proper process will be performed if possible other processes have been identified for that station. Additionally, the process data for each ball can be stored, and the ball can be uniquely identified in the future. This can assist in performance or warranty analysis.

In other words, when it is manufactured, an initial core can have an RFID tag embedded into it. Reader antennas can be located at the beginning of each ball process and can read the tag. The readers can send the ball/core tag ID or information along with the process to be performed to the computers/database to verify that the process to be performed is a proper and correct process. Upon verification, the process will be performed on the ball, and the database or tag will be updated. Where a core may become one of different types of balls, the tag or database will be updated to reflect those changes (e.g., different wall weight, different cover stock or engraving). The data for each ball can be maintained, so that it can be retrieved at any time.

This application helps solve the problems that occur due to the fact that a core or a ball is typically not identifiable. For example, many balls end up wrongly configured and end up as scrap, thus increasing manufacturing costs. Also, once a ball is finished, there is no way of knowing what is inside the ball without destroying it. By providing a mechanism of identification at an early stage, all processes performed on a ball or core will be the proper and correct processes to assure that the ball or core ends up being the correct end product. Since each ball is not uniquely identifiable, there is no way, once it has been produced, to be sure of what the process steps were to manufacture the product. The RFID tag can allow the unique identity of the ball to be maintained throughout its life.

An RFID tag in a bowling ball can also be used in a virtual bowling game to generate a more accurate calculation of the onward travel of the ball toward the pins and to present a more accurate image of the bowling ball on the screen. The RFID tag contained in the bowling ball can have a unique identifier within it, and a computer of the virtual bowling system can receive the unique identifier as the bowling ball is rolled down the bowling lane. The unique identifier can identify the bowling ball's color and weight or other information. An example of a virtual bowling game is described in U.S. patent application Ser. No. 10/487,056, filed Jun. 18, 2002, which is hereby incorporated by reference.

In another application, RFID tags in bowling balls can be used to provide a house ball location system. One of the most frustrating tasks for a new or infrequent bowler is finding a house ball that fits his hand, especially if the bowler has large hands or needs a lighter ball. An RFID house ball location system can facilitate that task. When a customer comes into a bowling center, he can specify the weight ball he wants and either state his hand size or have it automatically measured. The system can then tell him where he can find a house ball that will fit his hand and that will have the proper weight, if the house ball contains an RFID tag with a unique identifier. That identifier can either be a unique code that identifies that particular ball or can be encoded with the ball's weight and finger hole size. In the case where a simple unique number only identifies the ball, the ball weight and finger hole size information can be contained in an affiliated database. Balls with RFID tags in them can be located in “SmartRacks” that contain RFID readers. The information from the readers can be passed to a computer that stores and updates ball weight, finger hole size, and location. A biometric device can be used to measure the hand of a particular bowler. With the hand size known and the ball weight identified, the software can indicate the location of where the bowler may find a ball fulfilling the bowler's requirements. For frequent bowlers, this information can be stored with their personal data. That way, the next time they check in, be it at the front desk, at a kiosk, or at the lane, the location for the proper ball will be provided to them without any further action.

An RFID tag can also be used to generate information about the bowling ball. For example, serious bowlers continuously try to improve their scores by purchasing high performance balls, but they cannot really determine how the ball is reacting nor how consistent they throw the ball. An RFID tag in the ball can be used to provide “metadata” that can be used to determine the lateral and rotational accelerations and displacements as the ball is thrown down the lane. The ball could contain orthogonal accelerometers and rate gyros. The system can record rotational and lateral accelerations as the ball is thrown until it descends into the pit (a vertical acceleration can be determined). The data can be extracted from the ball using RFID technology and sent to a center management system if so equipped, thus saving pin data along with the ball data. The data can be downloaded from the system at the bowling center or downloaded from the web when the bowler returns home. Once at home, the bowler can analyze their particular ball data.

Data that can be calculated from the download includes, but is not limited to: ball velocity; ball path (graphics display) including curvature and entry angle to the pins; rotational velocity along the ball path; pins knocked down; with an adjunct ball location system providing the ball with one location along its trajectory, absolute position information would be part of the ball trajectory and would be related to pins; ball displacement after hitting the first pin would be available, providing a trajectory of the ball through the pins; and, if the center were equipped with an RFID pin sensing system, (such as the one disclosed in U.S. patent application Ser. No. 10/860,729, which is assigned to the assignee of the present application and is hereby incorporated by reference), it could provide the timing of pins getting knocked over.

An analysis program can be purchased by bowlers and used to analyze their throws (consistency, rotation, speed) relative to their accuracy. The power supply could be (1) kinetics (such as a Seiko kinetic that charges a capacitor and supplies power over a period of months (the motion of the ball provides the energy)), or (2) coils located within the ball but near the periphery (a charger could can be embedded within the ball return that charges the ball capacitor via magnetic induction or there could be a receptacle at the bottom of one of the finger holes for charging at home). This could also be used for bowling ball development.

The forgoing detailed description has described only a few of the many possible implementations of the present invention. For this reason, this detailed description is intended by way of illustration, and not by way of limitation. It is only the following claims, including all equivalents, that are intended to define the scope of this invention.

What is claimed is:

1. A bowling ball with a radio frequency identification (RFID) device, the bowling ball comprising:
a core;
an outer layer; and
a radio frequency identification (RFID) device.

2. The bowling ball of claim 1, wherein the RFID device is located in the core.

3. The bowling ball of claim 1, wherein the RFID device is integrated in the core during manufacturing.

4. The bowling ball of claim 1, wherein the RFID device is attached to the core during manufacturing.

5. The bowling ball of claim 1, wherein the core comprises an inner core and an outer core, and wherein the RFID device is located between the inner core and the outer core.

6. The bowling ball of claim 5, wherein, during manufacturing, the RFID device is attached to the inner core before the outer core is cast over the inner core.

7. The bowling ball of claim 1, wherein the RFID device is attached to the outer layer.

8. The bowling ball of claim 1, wherein the RFID device is located in the bowling ball at a location away from a location for a finger hole.

9. The bowling ball of claim 1, wherein the RFID device is encased in epoxy.

10. The bowling ball of claim 1, wherein the RFID device is encased in ceramic.

11. The bowling ball of claim 1, wherein the RFID device is encased in glass.

12. The bowling ball of claim 1, wherein the RFID device comprises plastic.

13. A method for manufacturing a bowling ball with a radio frequency identification (RFID) device, the method comprising:
providing a weight block material in a core mold;
providing an RFID device in the core mold; and
providing a core fill material in the core mold;

14. The method of claim 13, wherein the RFID device is provided in the core mold by suspending the RFID device in the core mold.

15. The method of claim 13, wherein the RFID device is provided in the core mold before the core fill material is provided in the core mold.

16. The method of claim 13, wherein the core fill material is provided in the core mold before the RFID device is provided in the core mold, and wherein the RFID device is provided in the core mold by pushing the RFID device into the core fill material in the core mold.

17. The method of claim 13, wherein the core fill material is provided in the core mold in increments, with some core fill material being provided in the core mold before the RFID device is provided in the core mold and additional core fill material being provided in the core mold after the RFID device is provided in the core mold.

18. The method of claim 13 further comprising:
attaching the RFID device to an inner core; and
casing an outer core over the inner core.

19. The method of claim 13, wherein the RFID device is made of a material that can withstand a temperature experienced during curing of the core fill material.

20. The method of claim 13, wherein the RFID device is encased in epoxy.

21. The method of claim 13, wherein the RFID device is encased in ceramic.

22. The method of claim 13, wherein the RFID device is encased in glass.

23. The method of claim 13, wherein the RFID device comprises plastic.

24. The method of claim 13, wherein the RFID device is provided in the core mold at a location that is away from a location for a finger hole.

25. The method of claim 13, wherein the core fill material comprises a resin having a first density, and wherein the weight block material comprises a resin having a second density greater than the first density.

26. The method of claim 13 further comprising:
removing a core from the core mold, wherein the core comprises the weight block material, the RFID device, and the core fill material;
providing the core in a ball mold; and
providing a resin in the ball mold, the resin being for an outer layer of the bowling ball.
